(19) United States
(12) Patent Application Publication
(10) Pub. No.: US 2014/0372302 A1
(43) Pub. Date: Dec. 18, 2014

(54) PAYMENT GATEWAY WITH GATEWAY DATABASE

(71) Applicant: Christopher West, Port Orange, FL (US)

(72) Inventor: Christopher West, Port Orange, FL (US)

(21) Appl. No.: 13/918,258

(22) Filed: Jun. 14, 2013

(51) Int. Cl. G06Q 20/02

(52) U.S. Cl. CPC G06Q 20/027
USPC 705/44

(57) ABSTRACT

A merchant server includes a payment gateway and a gateway database. The payment gateway receives payment information from a payment page. The payment gateway adjusts an amount to be paid to produce an adjusted amount to be paid. The payment gateway forwards the adjusted amount to a payment processing entity for payment approval. The database includes end user data accessible by an end user identifier generated by the payment gateway using selected items within the payment information. The amount to be paid is adjusted by the payment gateway based on end user data accessed from the gateway database.

### BACKGROUND

Electronic payments are frequently made over the Internet. For an electronic commerce transaction to take place over the Internet, there are a number of typical steps. The end user usually needs to access the merchant's online store and be able to place desired items into a shopping cart. The end user then is presented a payment page into which the end user enters in payment information. This information is sent to a payment gateway that takes the data and channels it through the appropriate credit card networks and relays back the response.

Marketing to end users that is tied into a payment solution—such as a gift card, loyalty program, affiliate tracking or social media tracking (whereby compensation or rewards can be offered to individuals or businesses who promote the merchant)—require a high degree of integration and cooperation between a shopping cart, a payment page and a payment gateway. Without this tight integration these types of payment solutions to marketing are typically not available.

Even when there exists a high degree of integration and cooperation between a shopping cart, a payment page and a payment gateway, this may not be portable when a merchant moves to a different shopping cart or payment page.

### BRIEF DESCRIPTION OF THE DRAWING

FIG. 1 is a simplified block diagram illustrating how a merchant server can work with a payment processing network to provide payment transactions over the Internet in accordance with an embodiment.

FIG. 2 is a simplified block diagram of entities within the merchant server shown in FIG. 1 in accordance with an embodiment.

FIG. 3 shows an example merchant payment page in accordance with the prior art.

FIG. 4 is a simplified flow chart illustrating customer relationship management functions being integrated within a payment gateway in accordance with an embodiment.

### DESCRIPTION OF THE EMBODIMENT

In accordance with various embodiments disclosed herein, a merchant is able to offer a large array of marketing and customer relationship management (CRM) functions strictly on a payment gateway level and completely independent of a shopping cart and payment web page. The marketing and CRM functions on the payment gateway are implemented to work seamlessly with a shopping cart and payment web page. Information passed from the shopping cart and payment web page to a payment gateway on a back-end and in real-time is used to identify an end user (i.e., a customer) and to immediately apply discounts and other available benefits available to the end user.

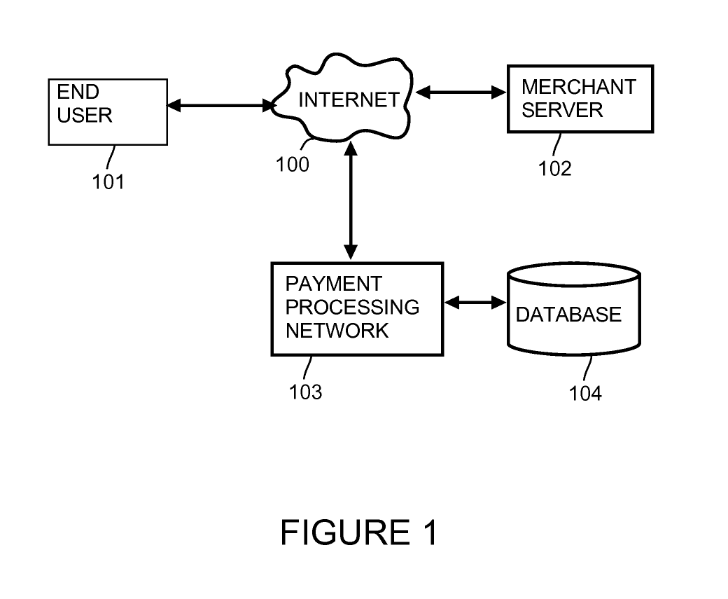

FIG. 1 shows an end user 101 in contact with a merchant server 102 through Internet 100. A merchant server is a computer server, including hardware, that is used by a merchant to sell goods and or services. Merchant server 102 allows end user 101 to select products and/or services for purchase. Once selections for purchase are made and payment information is gathered from the end user, merchant server 102 sends the payment information to a payment processing network 103. Payment information indicates how a purchase is to be paid for. For example, the purchase may by paid for by credit card, debit card, bank account transfer or by some other way money can be delivered to the merchant for the purchase. Payment processing network 103 processes the payment information and indicates to merchant server 102 whether payment is successful.

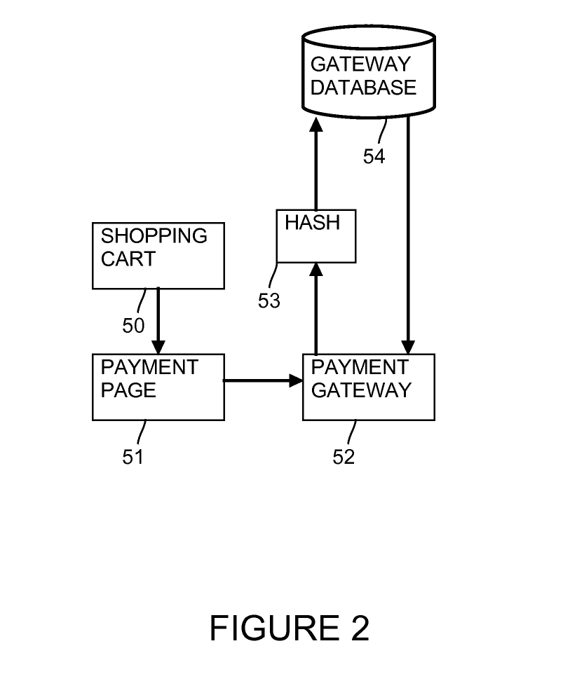

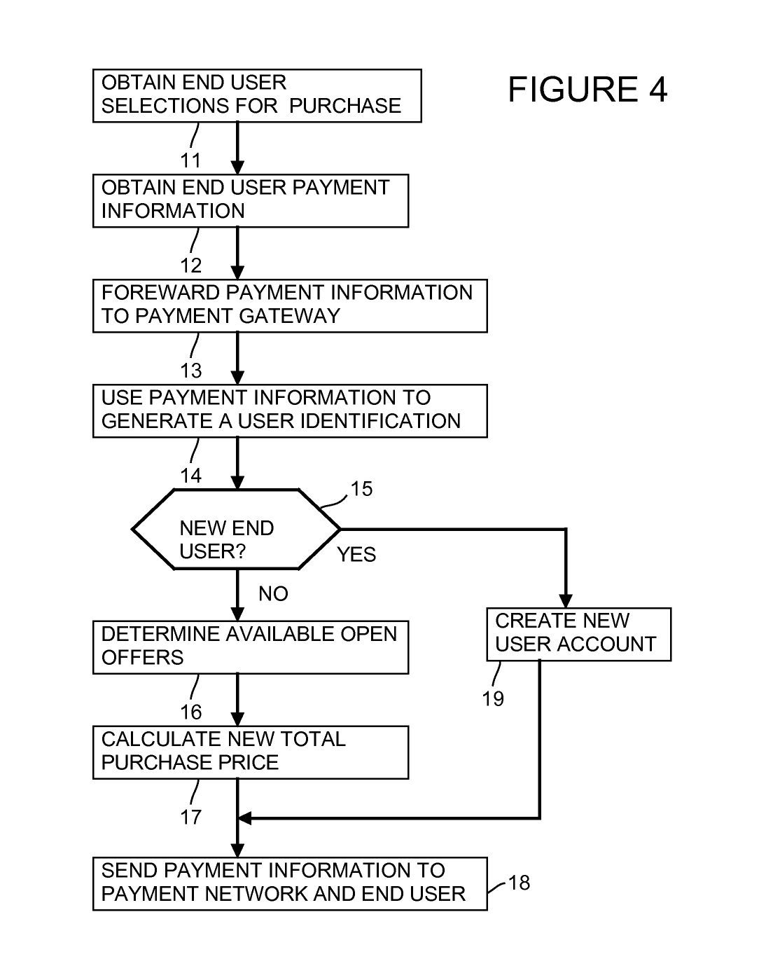

FIG. 2 is a simplified block diagram of pertinent entities within merchant server 102. Merchant server 102 allows end user 101 to select items to purchase by placing them in a shopping cart 50. Once end user 101 finalizes items to be purchased, end user 101 is presented with a payment page 51 into which end user 101 can provide payment information. FIG. 4 is an example of a user view of payment page 51. End user 101, in an area 62, can provide both billing information and shipping information to be used by merchant server 102 for the purchase.

From payment page 51, a user selects “check out” or in some other way indicates a readiness to complete a purchase. The payment information is then forwarded to a payment gateway 52 that formats the payment information and sends it to payment processing network 103.

Marketing and CRM functions are accessed and utilized after the payment information is forwarded from payment page 51 to payment gateway 52. This allows marketing and CRM functions to be offered without affecting operation of shopping cart 50 or payment page 51. To access available marketing and CRM information for end user 101, payment gateway 52 generates an end user identification from payment information received from payment page 50. For example, payment gateway 52 uses a hashing function 53 to generate the end user identification by hashing information provided by payment page 51. The hashed information can include, for example, some combination of credit card number, expiration date and any other selected information provided by the payment page 51 or otherwise available to merchant server 102. The selected information can be, for example, a merchant identifier, customer name, customer address, and so on. Alternatively, payment gateway can generate the end user identification some other way, for example, using a look-up table or using a secure algorithm that is not a hashing algorithm.

The generated end user identification is used to access customer information within a gateway database 54. Gateway database 54 is implemented so as to include physical (hardware) storage components used to store data. The customer information pertaining to end user 101 can contain marketing and CRM information such as available discounts, gift cards, loyalty programs, affiliate tracking or social media tracking. Payment gateway 52 can automatically utilize the discounts or gift card balances in adjusting the amount to be obtained from payment processing network 103, or can give the end user the option to apply whatever additional discounts or payment options are made available to end user 101 as a result of payment gateway 52 obtaining customer information on end user 101 from gateway database 54.

FIG. 4 is a simplified flow chart illustrating customer relationship management functions being integrated with payment gateway 52 in accordance with an embodiment.

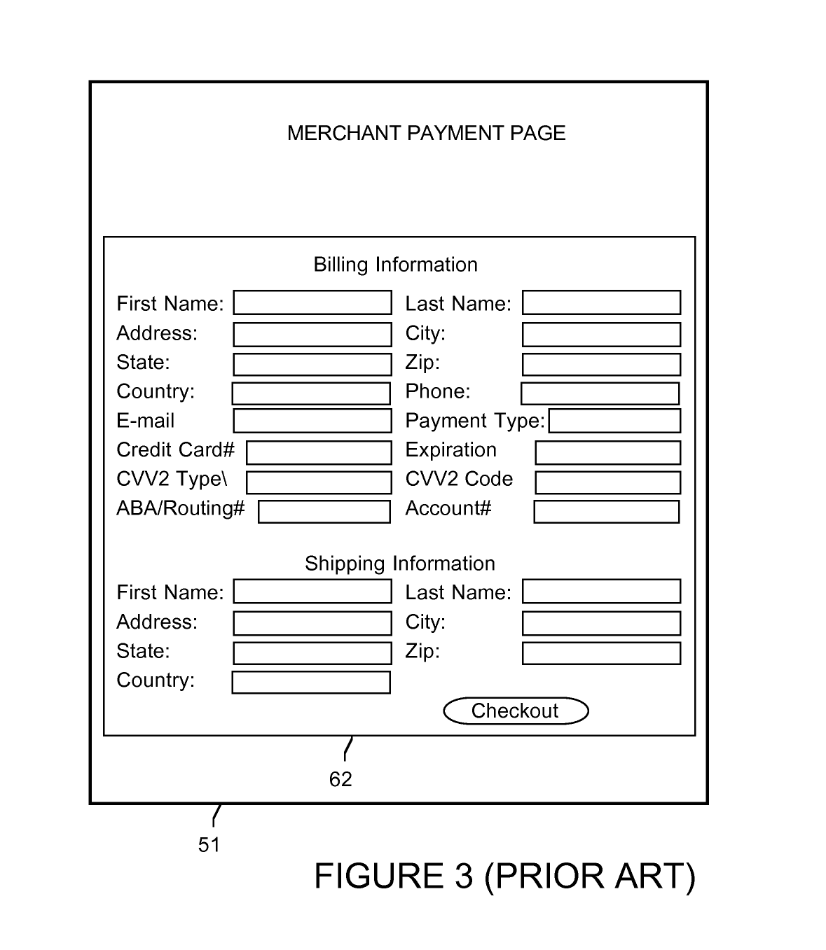

In a block 11, user selections for purchase are obtained. This is accomplished, for example, by a shopping card feature implemented within merchant server 102 or some other server accessible by merchant server 102 or end user 101. In a block 12, user payment information is obtained. This is accomplished, for example, by a payment web page implemented within merchant server 102 or some other server accessible by merchant server 102 or end user 101. As discussed above, FIG. 3 shows a simplified example of a payment web page.

In a block 13, the payment information is forwarded to payment gateway 52. The user information is used to generate a user identification. For example, as discussed above, this is performed by using a hashing algorithm or some or method to generate the user identification. Once generated, the user identification is used to access gateway database 54 where information on end users is stored. In block 15, a determination is made, based on the generated user identification, as to whether the user identification for end user 101 is already in gateway database 54. If the determination indicates end user 101 is a new user whose user identification is not in gateway database 54, in a block 19 a new user account is created for end user 101. An entry in gateway database 54 for the new user account is populated with information on the new user. This can include marketing information as well as offers and so on that can be made available to end user 101 for future purchases. In a block 18, the payment information is sent on to payment processing network 103 and to end user 101.

If in block 15, the determination indicates end user 101 is not a new user, i.e., a user identification for end user 101 corresponding to the generated user identification is already in gateway database 54, in a block 16 information on end user 101 is accessed from gateway database 54 and used to determine what open offers, gift cards, et cetera, are available for end user 101 to utilize in the purchase. These can be applied automatically, or displayed to end user 101 to allow end user 101 to confirm a desire to use. Also, the stored information associated with end user 101 is adjusted to include marketing information such as utilized offers, adjusted gift card balances, new offers that can be utilized in future purchases and so on. In a block 17, a new purchase price is calculated. In block 18, the payment information is sent on to payment processing network 103 and end user 101. The payment information sent to end user 101, can be in the form of one or more receipts indicating a successful purchase. Alternatively, if the purchase is not approved by payment processing network 103, the payment information sent to end user 101 may be a notice that the transaction was not completed.

For example, if end user 101 has a gift card balance of $ 50 for a merchant and end user 101 has accumulated a total purchase price of $100.00, the gift card would be discovered in block 16 and applied in block 17. In block 18, payment gateway 52 will indicate to payment processing network 103 that a $ 50 charge is to be made to a credit card or a debit card of end user 101. Two receipts would be generated for end user 101. One receipt would show the $50 debit made to the gift card and the other receipt would show the $50 charge to a credit card or a debit card of end user 101.

For example, suppose end user 101 is enrolled in a loyalty program. The logic behind a loyalty program is limited only by the imagination of the merchant. For example, take the case of a loyalty program where there is a $5 discount every fifth purchase that end user 101 makes from the merchant. Suppose this was the fifth purchase for end user 101. The loyalty program and end user status would be discovered in block 16 and applied in block 17. In block 18, payment gateway 52 will indicate to payment processing network 103 a $ 95 charge is to be made to a credit card or a debit card of end user 101. Two receipts would be generated for end user 101. One receipt would show the $5 discount and the other receipt would show the $95 charge to a credit card or a debit card of end user 101.

For example, the merchant stores information on gateway database 54 for each end user that pertains to time and date of sale. Payment gateway 52 records this time and date information with the consumer identification on gateway database 54. This allows the merchant, using the capability of payment gateway 52 or some other entity with access to gateway database 54, to generate e-mails, text messages or other communications that are transmitted to end user 101, for example, at the same time of day or even day of the week that each end user last placed an order. The logic behind this strategy is that people are habitual and often will spend time on a computer at a same time of the day or of the week. Thus, sending communications at such a time may increase the likelihood that a fresh e-mail delivered near such a time will catch an end user reviewing communications such as e-mail. This timing may help an e-mail be read immediately after being sent, rather than being at the middle or bottom of a stack of other dated e-mails.

For example, information gathered into gateway database 54 from transactions through payment gateway 52 could be used to deduce demographic information about end user 101. This could assist a merchant in creating target groups of end users for promotion. For example, end users could be grouped based on estimated affluence, geographic location or other factors. For example, estimates of affluence might be based on zip codes. Zip codes might also help for geographic promotions. For example, snow shovels might be more successfully marketed to end users with a zip code indicating a residence in Vermont than to end users with a zip code indicating a residence in Hawaii. And so on.

For example, information stored in gateway database 54 can allow a more convenient check out for end users. For example, a merchant could send out a number of targeted promotions to end users along with some way to separately identify the end users. For example a hyperlink for the promotion could be generated for each end user. When an end user accessed such a hyperlink, it could be assumed the end user that associated the hyperlink was the targeted end user. Gateway database 54 could then be accessed using the information to obtain mailing address, credit card information, and etc. about end user 101. This could simplify the process by which end user 101 makes a purchase by limiting the amount of information end user 101 has to enter. Perhaps end user 101 might only need to respond to an offer and provide a 3 or 4 digit Card Validation Value (CW) to satisfy security and validation requirements. For example, a merchant might send out an e-mail to a thousand end users. Each hyperlink would be different and specific to each individual end user. Hyperlinks could be individualized based on an inclusion in each hyperlink of a tracking identifier (ID). When end user 101 clicks on such a hyperlink, a page can be generated by payment gateway 52, or other appropriate entity on the merchant server, that then pitches an offer or offers, to end user 101 for a product or products. The presentation of the offer may include for example, a picture of the product and/or other details of the product and offer. The hyperlink will identify end user 101 to merchant server 102 and allow merchant server 102 to obtain payment information from gateway database 54 rather than from end user 101.

For example, such a hyperlink and information placed in gateway database 54 by payment gateway 52 can also be used for affiliate tracking. For example, if end user 101 passes along a designated hyperlink to an other end user, when the other end user activates the hyperlink and subsequently places an order with the merchant, the merchant will know that the hyperlink was originally sent to end user 101. This allows the merchant to credit end user 101 with an affiliate assist to the sale to the other end user. In gateway database 54, end user 101 can be credited with the sale assist, and for example, can be granted a discount on a next purchase. Alternatively, or in addition, end user 101 can be provided with some other form of compensation or benefit.

For example, such a hyperlink, tracked to a specific end user, could be provided to end user 101 in a variety of ways. For example the hyperlink could be provided via e-mail, a web site, through printed marketing material, through a message on a Facebook account, via a tweet on a Twitter account, or through some other social media or other communication system.

For example, such hyperlinks, each tracked to a specific end user, can also be used to deliver discount codes from a merchant. For example, a merchant using information stored in gateway database 54 by payment gateway 52 could send out discount code hyperlinks to its end users. In the event that end user 101 clicked on the hyperlink, the discount would be activated within gateway database 54. When end user 101 subsequently purchases the product and payment gateway 52 uses the generated end user identification to obtain CRM and marketing information on end user 101, the activated discount would be discovered and applied. For example, end user 101 would then receive two receipts as a result of the purchase. One receipt would show, for example, a $10 discount and the other receipt would show a $90 charge to a credit card or a debit card of end user 101.

For example, information stored in gateway database 54 can also be used by a merchant to generate special event e-mails. These could be, for example, e-mails, texts or other notifications sent to end users on special events ranging from holidays and merchant-designated days to specific events such as the anniversary of end user's first order with the merchant.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

What is claimed:

1. A merchant server, including hardware, comprising:
a payment gateway, the payment gateway receiving payment information from a payment page, the payment gateway adjusting an amount to be paid to produce an adjusted amount to be paid, and the payment gateway forwarding the adjusted amount to a payment processing entity for payment approval; and, a gateway database, the database including end user data accessible by an end user identifier generated by the payment gateway using selected items within the payment information, wherein the amount to be paid is adjusted by the payment gateway based on end user data accessed from the gateway database.

2. A merchant server as in claim 1 additionally comprising:
a hashing function used by the payment gateway to generate the end user identifier.

3. A merchant server as in claim 1 additionally comprising:
a hashing function used by the payment gateway to generate the end user identifier;
wherein the selected items within the payment information include a credit card number and a credit card expiration date.

4. A merchant server as in claim 1 wherein the selected items within the payment information include a credit card number and a credit card expiration date.

5. A merchant server as in claim 1 wherein the end user data accessed from the gateway database by the payment gateway includes information pertaining to a gift card for the end user.

6. A merchant server as in claim 1 wherein the end user data accessed from the gateway database by the payment gateway includes information pertaining to a reward for a loyalty program for which the end user is eligible.

7. A computer implemented method for completing a purchase transaction, the computer implemented method comprising:
providing payment information received from an end user in a payment information page to a payment gateway, the payment information including an amount to be paid for a transaction;
generating, by the payment gateway, an end user identification from selected items within the payment information received from the end user;
using the end user identification to access end user data from a gateway database;
using the end user data accessed from the gateway database to adjust the amount to pay be paid for the transaction to produce an adjusted amount to be paid; and,
sending the adjusted amount to be paid along with addition selected items from the payment information to a payment processing network for approval.

8. A computer implemented method as in claim 7 additionally comprising:
obtaining end user selections for purchase using a shopping cart.

9. A computer implemented method as in claim 7 additionally comprising:
creating a new user account for a new end user when an end user identification generated by the gateway database for the new end user does not have a matching entry within the gateway database.

10. A computer implemented method as in claim 7 wherein the end user identification is generated by a hashing function that performs a hash of the selected items within the payment information.

11. A computer implemented method as in claim 7 wherein the end user identification is generated by a hashing function that performs a hash of the selected items within the payment information to produce the end user identification.

12. A computer implemented method as in claim 7 wherein the amount to pay be paid for the transaction is adjusted by subtracting an available gift card balance.

13. A computer implemented method as in claim 7 wherein the amount to pay be paid for the transaction is adjusted by subtracting a discount amount that according to the end user data is available to the end user.

14. A computer implemented method as in claim 7 additionally comprising:
sending a first receipt and a second receipt to the end user, the first receipt showing the adjusted amount and the second receipt showing an amount adjusted and a reason for adjustment.

15. A computer implemented method as in claim 7 additionally comprising:
storing information about the purchase transaction in the gateway database, the information about the purchase transaction including time and date information; and,
using the time and date information stored about the purchase transaction to select a time to send a future marketing communication to the end user.

16. A computer implemented method as in claim 7 additionally comprising:
storing information about the purchase transaction in the gateway database; and,
using end user data stored with gateway database to deduce demographic information about the end user.

17. A computer implemented method as in claim 7 additionally comprising:
sending a targeted promotion to the end user, the targeted promotion including a hyperlink that is unique to the end user.

18. A computer implemented method as in claim 7 additionally comprising:
sending a targeted promotion to the end user, the targeted promotion including a hyperlink that is unique to the end user; and,
using accesses to the hyperlink to help identify when the end user responds to the promotion.

19. A computer implemented method as in claim 7 additionally comprising:
sending a targeted promotion to the end user, the targeted promotion including a hyperlink that is unique to the end user; and,
using accesses to the hyperlink for affiliate tracking.

20. A computer implemented method as in claim 7 additionally comprising:
sending a targeted promotion to the end user, the targeted promotion including a hyperlink that is unique to the end user, the hyperlink being used to deliver a discount code.
